(19) United States
(12) Patent Application Publication
(10) Pub. No.: US 2010/0168964 A1
(43) Pub. Date: Jul. 1, 2010

(54) MOTOR VEHICLE STEERING APPARATUS

(76) Inventors: Kenji Higashi, Osaka (JP); Kosuke Yamanaka, Osaka (JP); Atsushi Ishihara, Osaka (JP); Daisuke Maeda, Osaka (JP); Masami Naka, Osaka (JP); Tomoyasu Kada, Osaka (JP)

Correspondence Address: RABIN & Berdo, PC, 1101 14TH STREET, NW, SUITE 500, WASHINGTON, DC, 20005, US

(21) Appl. No.: 12/444,250

(22) PCT Filed: Oct. 1, 2007
(86) PCT No.: PCT/JP2007/069173

§ 371 Date: Mar. 9, 2010

(30) Foreign Application Priority Data
Oct. 3, 2006 (JP) 2006-272095

(51) Int. Cl. B62D 6/00; B62D 5/04; B62D 5/07

(52) U.S. Cl. 701/42

(57) ABSTRACT

A motor vehicle steering apparatus (1) has a transmission-ratio variable mechanism (8) for changing, with the use of a transmission-ratio changing motor (18), the rotational transmission-ratio between a first steering shaft (5) connected to a steering member (2) and a second steering shaft (6) connected to a steering mechanism (12). The apparatus has a counter force compensating motor (23) for compensating steering counter force of the steering member (2) caused by operation of the transmission-ratio variable mechanism (8), a hydraulic steering assist mechanism (80), and a controller (24) for controlling the transmission-ratio changing motor (18) and the counter force compensating motor (23). The controller (24) has a function of causing the counter force compensating motor (23) to generate steering assist torque.

### BACKGROUND OF THE INVENTION

1. Field of the Invention

The present invention relates to a motor vehicle steering apparatus.

2. Description of Related Art

There has been proposed a motor vehicle steering apparatus for performing a so-called active steering in which by control of an actuator, a ratio between the steering angle of a steering member such as a steering wheel and the steered angle of a steered wheel is changed, and the steered angle is thereby changed irrespective of a driver' s intention.

For example, if a motor vehicle is in an over-steering state as a result of traveling along a snow-covered road, a motor vehicle posture can be stabilized by performing active steering so that the steered angle is changed in a direction opposite to a steering direction of a steering member.

Usually, in a motor vehicle (a full-sized vehicle, a luxury vehicle, etc.) mounted with an active steering function, a large steering assist force is required, and thus, it is suitable to combine a hydraulic power steering mechanism that provides large output.

There has been proposed a motor vehicle steering apparatus mounted thereon with the hydraulic power steering mechanism and a transmission-ratio variable mechanism.

However, a steering gear ratio is varied by working of the transmission-ratio variable mechanism, and thus, a flow rate of a working fluid required by the power cylinder is changed. When a discharge flow rate of a hydraulic pressure pump of the hydraulic power steering mechanism becomes insufficient for the required flow rate, generated steering assist force also becomes insufficient. As a result, a force required for operating a steering member such as a steering wheel becomes excessive, and thus, steering feeling may become degraded.

On the other hand, the discharge flow rate can be set according to a case where the steering gear ratio is set to the quickest side by means of the transmission-ratio variable mechanism. However, in this case, most of the discharge flow rate of the hydraulic pressure pump is wasted, and as a result, the energy-saving effect may be restrained.

To solve such problems, there has been proposed a motor vehicle steering apparatus for controlling a flow rate control valve composed of a magnetic valve of the hydraulic power steering mechanism according to a difference between a detection ACT angle and a target ACT angle of an electric motor for changing a transmission ratio of a transmission-ratio variable mechanism (see Patent Document 1).

### Patent Document 1: Japanese Published Unexamined Patent Application No. 2005-225402

### DISCLOSURE OF THE INVENTION

### Problems to be Solved by the Invention

In the motor vehicle steering apparatus of the Patent Document 1, its application is restricted to an apparatus using a magnetic valve as a flow rate control valve. Therefore, irrespective of the use of the magnetic valve as a flow rate control valve, a motor vehicle steering apparatus having a high versatility, capable of solving the above-described problems is desired.

An object of the present invention is to provide a motor vehicle steering apparatus that provides a good steering feeling and has a high degree of versatility.

### Means for Solving the Problem

To achieve the above-described object, a preferable mode of the present invention provides a motor vehicle steering apparatus, including: a transmission-ratio variable mechanism for changing a transmission ratio of a rotation between a first steering shaft coupled to a steering member and a second steering shaft coupled to a steering mechanism; a transmission-ratio changing motor for changing the transmission ratio of the transmission-ratio variable mechanism; a counter force compensating motor for compensating a steering counter force of the steering member caused by an operation of the transmission-ratio variable mechanism; a hydraulic steering assist mechanism; and a controller for controlling the transmission-ratio changing motor and the counter force compensating motor, in which the controller includes a function for generating a steering assist torque in the counter force compensating motor.

In this mode, the steering assist force by the counter force compensating motor is added to the steering assist force by the hydraulic steering assist mechanism. Therefore, a large steering assist force required for a motor vehicle such as a full-sized vehicle and a luxury vehicle mounted with the active steering function can be obtained, and thus, the present invention can be suitably applied to these vehicles. Further, the steering assist torque is obtained by the counter force compensating motor, and thus, the following advantages are provided: That is, as compared to the conventional apparatus where the flow rate of the hydraulic pressure pump is increased, a rise of the torque is more immediate, and therefore, a problem of the insufficient steering assist force can be reliably solved, and thereby, a good steering feeling can be provided. Further, the present invention can be applied to a wider torque band. Also, irrespective of the presence of a flow-rate control valve, the present invention can be applied to various types of hydraulic power steering apparatuses, and thus, a high versatility is provided. Moreover, a problem of the insufficient steering assist force encountered at the time of stationary steering (which is difficult to solve in the conventional apparatus where the flow rate of the hydraulic pressure pump is increased) can be solved.

In addition, the steering assist control is required when the steering assist force is insufficient, and at that time, the sufficient steering counter force has been given to the driver via the steering member, and thus, the counter force compensating control needs not to be carried out. On the other hand, the counter force compensating control is that which is required at the time of active steering such as if the motor vehicle is in an over-steering state, for example, as a result of traveling along a snow-covered road with a small road surface resistance, the steered angle is automatically changed to a direction opposite to the steering direction of the steering member (counter is automatically provided). The load at the time of such an active steering is small, and thus, the steering assist control will not be required. That is, there is no possibility that the steering assist control and the counter force compensating control are simultaneously carried out, and therefore, the steering torque is not adversely affected, resulting from the interference between both controls.

### BRIEF DESCRIPTION OF THE DRAWINGS

FIG. 1 is a schematic diagram showing an approximate configuration of a motor vehicle steering apparatus of one embodiment of the present invention.

FIG. 2 is a flow chart showing a flow of steering assist control by a counter force compensating motor in the motor vehicle steering apparatus in FIG. 1.

FIG. 3 is a flow chart showing a flow of steering assist control by a counter force compensating motor, in another embodiment of the present invention.

FIG. 4 is a flow chart showing a flow of steering assist control by a counter force compensating motor, in still another embodiment of the present invention.

FIG. 5 is a flow chart showing a flow of steering assist control by a counter force compensating motor, in yet still another embodiment of the present invention.

FIG. 6 is a flow chart showing a flow of steering assist control by a counter force compensating motor, in another embodiment of the present invention.

FIG. 7 is a schematic perspective view of a driving system when a hydraulic pump of a hydraulic steering assist mechanism is a hybrid drive in still another embodiment of the present invention.

FIG. 8 is a schematic diagram of a drive pulley and a restraining member when the drive pulley is restrained in the embodiment in FIG. 7.

FIG. 9 is a schematic diagram of a ring gear and a restraining member when the ring gear is restrained in the embodiment in FIG. 7.

### DETAILED DESCRIPTION OF PREFERRED EMBODIMENTS

Preferred embodiments of the present invention will be described with reference to the accompanying drawings.

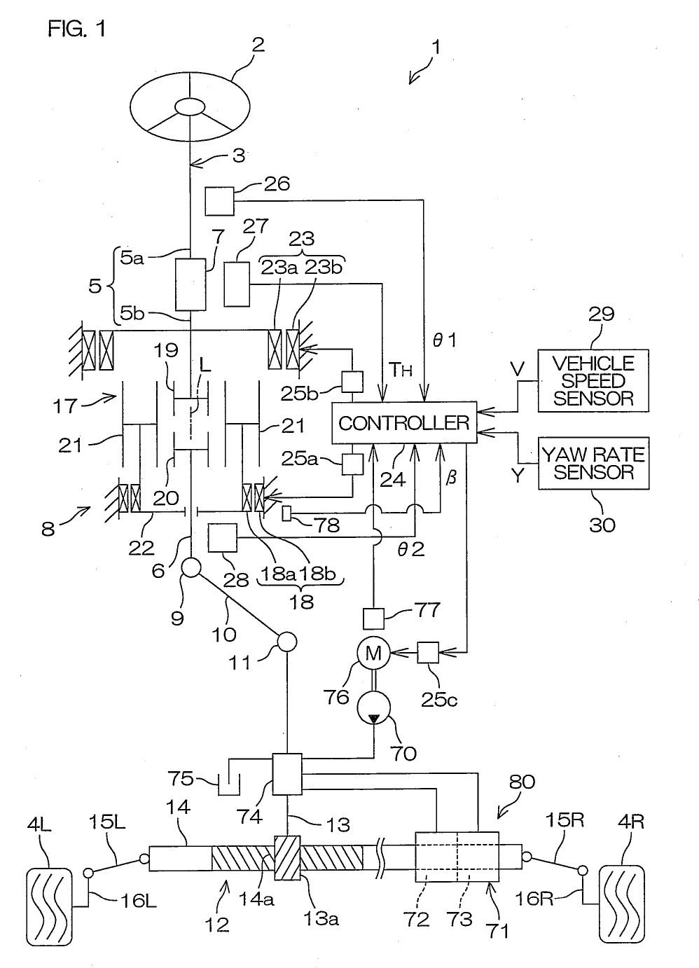

FIG. 1 is a schematic diagram showing an approximate configuration of a motor vehicle steering apparatus of one embodiment of the present invention. With reference to FIG. 1, a motor vehicle steering apparatus 1 includes a steering member 2 such as a steering wheel and a steering shaft 3 continued to the steering member 2. The motor vehicle steering apparatus 1 applies a steering torque imparted to the steering member 2 to each of right and left steered wheels 4L and 4R (or steered members) via a steering shaft 3 (or steering shaft), etc., and performs a steering operation.

The steering shaft 3 includes a first steering shaft 5 and a second steering shaft 6 placed coaxially with the first steering shaft 5. The motor vehicle steering apparatus 1 includes a variable gear ratio function capable of changing a ratio (equivalent to a transmission ratio R (R=θ2/θ1)) of a rotation angle (equivalent to a steered angle θ2) of the second steering shaft 6 to a rotation angle (equivalent to a steering angle θ1) of the first steering shaft 5.

The first steering shaft 5 includes an input shaft 5a coupled to the steering member 2 and an output shaft 5b coupled relatively rotatably via a torsion bar 7 to the input shaft 5a.

Between the output shaft 5b of the first steering shaft 5 and the second steering shaft 6, a transmission-ratio variable mechanism 8 is arranged. The transmission-ratio variable mechanism 8 is able to change the transmission ratio R (=θ2/θ1) between the first steering shaft 5 and the second steering shaft 6. The second steering shaft 6 is continued via a universal joint 9, an intermediate shaft 10, a universal joint 11, and a steering mechanism 12, to the steered wheels 4L and 4R.

The steering mechanism 12 is configured by a rack and pinion mechanism. That is, the steering mechanism 12 includes a pinion shaft 13 continued to the universal joint 11 and a rack shaft 14 (as a steered shaft) which has a rack 14a meshed with a pinion 13a at the distal end of the pinion shaft 13 and which extends in right and left directions of the motor vehicle. Each end of the rack shaft 14 is coupled with the corresponding steered wheel 4L or 4R via the corresponding tie rod 15L or 15R and the corresponding knuckle arm 16L or 16R.

The motor vehicle steering apparatus 1 is configured as a hydraulic power steering apparatus. That is, the pinion shaft 13 has an input shaft and an output shaft coupled relatively rotatably to each other via the torsion bar. In the pinion shaft 13, a rotary valve 74 (as a well-known hydraulic pressure control valve) for supplying either one of a pair of oil chambers 72 and 73 of the power cylinder 71 with pressure oil from a hydraulic pressure pump 70 according to a relative rotation of the input shaft and the output shaft thereby to generate a steering assist force is arranged.

In the rotary valve 74, when the input shaft and the output shaft are relatively rotated during steering, a flow route is controlled, and thereby, the pressure oil is supplied to either one of the oil chambers 72 and 73 of the power cylinder 71 while the oil from the other one of the oil chambers 72 and 73 is fed back to a reservoir tank 75, for example. The hydraulic power steering apparatus of the present embodiment is a motor-driven pump hydraulic power steering apparatus configured to rotation-drive the hydraulic pressure pump 70 by an electric motor 76. An electric current sensor 77 for detecting an electric current passing in the electric motor 76 is arranged. By the power cylinder 71, the rotary valve 74, the hydraulic pressure pump 70, the electric motor 76, etc., a hydraulic steering assist mechanism 80 is configured.

According to the above-described configuration, the steering torque from the steering member 2 is transmitted via the first steering shaft 5, the transmission-ratio variable mechanism 8, the second steering shaft 6, etc., to the steering mechanism 12. In the steering mechanism 12, the rotation of the pinion 13a is converted to a motion in an axial direction of the rack shaft 14, and as a result, the steered wheels 4L and 4R are steered via the tie rods 15L and 15R and the knuckle arms 16L and 16R.

The transmission-ratio variable mechanism 8 includes a planetary gear mechanism 17 for providing a planetary transmission mechanism (as a differential mechanism) for coupling differentially rotatably the output shaft 5b of the first steering shaft 5 to the second steering shaft 6. A transmission-ratio changing motor 18 drives the planetary gear mechanism 17 for changing the transmission ratio.

The planetary gear mechanism 17 has: a first sun gear 19 (as a first element) that can integrally rotate with the output shaft 5b of the first steering shaft 5; a second sun gear 20 (as a second element) that can rotate integrally with the second steering shaft 6, placed in a manner that the second sun gear 20 and the first sun gear 19 are faced to each other; a planetary gear 21 (as a third element) that is meshed with both the first and second sun gears 19 and 20; and a carrier 22 for holding the planetary gear 21 in a manner to permit rotation around an axial line thereof and to permit revolution around the first and second sun gears 19 and 20.

The first and second sun gears 19 and 20 and the planetary gear 21 are each arranged as a rotation transmission element, and are formed by using a helical gear, for example. In addition, instead of the helical gear, a spur gear and any other parallel shaft gear may be used.

The planetary gear 21 is for associating the first and second sun gears 19 and 20 (as the first and second elements) to each other, and a plurality of (two, in the present embodiment) planetary gears 21 are placed in a circumferential direction of the steering shaft 3. The axial line of each planetary gear 21 extends parallel with an axial line L of the steering shaft 3. The carrier 22 can rotate around the axial line L of the steering shaft 3. In the planetary gear 21, the teeth number in a portion meshed with the first sun gear 19 and that in a portion meshed with the second sun gear 20 are the same.

The teeth number of the first sun gear 10 and that of the second sun gear 20 differ from each other, and the first sun gear 10 is formed by using a profile shifted gear. The profile shifted gear is transformed in a direction in which the diameter of a pitch circle is smaller or a direction in which the same is larger.

The transmission-ratio changing motor 18 is for rotation-driving the carrier 22. When the number of rotations of the carrier 22 rotating around the axial line L is changed, the transmission ratio R can be changed. The transmission-ratio changing motor 18 is composed of a brushless motor, for example, and is placed coaxially with the steering shaft 3.

The transmission-ratio changing motor 18 includes an annular rotor 18a fixed to integrally rotate with the carrier 22 and an annular stator 18b surrounding the rotor 18a. Axial lines of the rotor 18a and the stator 18b each match the axial line L of the steering shaft 3. Further, a rotation angle sensor 78 (as rotation angle detecting means composed of a resolver, etc., for example) for detecting an ACT angle that is a motor rotation angle of the transmission-ratio changing motor 18 is arranged.

The motor vehicle steering apparatus 1 further includes a counter force compensating motor 23 (as a counter force compensating actuator) for compensating the steering counter force of the steering member 2 in association with the operation of the transmission-ratio variable mechanism 8. The counter force compensating motor 23 is composed of a brushless motor, for example, and is placed coaxially with the steering shaft 3.

The counter force compensating motor 23 includes an annular rotor 23a coupled to integrally rotate with the output shaft 5b of the first steering shaft 5 and an annular stator 23b surrounding the periphery of the rotor 23a. Axial lines of the rotor 23a and the stator 23b each match the axial line L of the steering shaft 3.

The transmission-ratio changing motor 18 and the counter force compensating motor 23 are each controlled by a controller 24 including a CPU, a RAM, and a ROM. The controller 24 is connected via a driving circuit 25a to the transmission-ratio changing motor 18 and connected via a driving circuit 25b to the counter force compensating motor 23. The controller 24 is further connected via a driving circuit 25c to the electric motor 76 for driving the hydraulic pressure pump 70.

Also, the controller 24 is connected with: a steering angle sensor 26 (steering angle detection means); a torque sensor 27 (steering torque detection means); a steered angle sensor 28 (steered angle detection means); a speed sensor 29 (vehicle speed detection means); a yaw rate sensor 30 (yaw rate detection means); an electric current sensor 77; and a rotation angle sensor 78 (rotation angle detection means).

From the steering angle sensor 26, as a value corresponding to the steering angle θ1 that is an operation amount from a directly advancing position of the steering member 2, a signal about the rotation angle of the first steering shaft 5 is input. From the torque sensor 27, as a value corresponding to the steering torque T_{H} of the steering member 2, a signal about the transmission torque in the first steering shaft 5 is input.

From the steered angle sensor 28, as a value corresponding to the steered angle θ2, a signal about the rotation angle of the second steering shaft 6 is input. From the speed sensor 29, a signal about a vehicle speed V is input. From the yaw rate sensor 30, a signal about a yaw rate Y of the motor vehicle is input. From the electric current sensor 77, a signal about a driving electric current of the electric motor 76 for driving the hydraulic pressure pump 70 is input. From the rotation angle sensor 78, a signal about an ACT angle β that is the motor rotation angle of the transmission-ratio changing motor 18 is input.

The controller 24 controls driving of the transmission-ratio changing motor 18 and the counter force compensating motor 23, as described below, for example. That is, the controller 24 computes a target yaw rate Y* (Y*=G×θ1: G denotes a predetermined transfer function) from the steering angle θ1 detected by the steering angle sensor 26, and computes a judgment value A=θ2×(Y*−Y) from the target yaw rate Y*, and the steered angle θ2 and the yaw rate Y* detected by the steered angle sensor 28.

When the judgment value A is zero, the detected yaw rate Y and target yaw rate Y* are equal, and the motor vehicle is in a neutral steering state, the controller 24 drives the transmission-ratio changing motor 18 so that the rotation speed of the carrier 22 matches that of the output shaft 5b of the first steering shaft 5. Thereby, the transmission ratio R (R=θ2/θ1) is one, and thus, there is no change.

At this time, a relationship between the steering angle θ1 and the steering torque T does not necessarily change resulting from the operation of the transmission-ratio variable mechanism 8, and thus, it is not necessary to compensate for the steering counter force (equivalent to the steering torque T_{H}) of the steering member 2, and thus, the counter force compensating motor 23 is not driven.

On the other hand, when the judgment value A is negative, i.e., when the detected yaw rate Y exceeds the target yaw rate Y*, and thus, the motor vehicle is in an over-steering state, or when the judgment value A is positive, i.e., when the detected yaw rate Y falls below the target yaw rate Y*, and thus, the motor vehicle is in an under-steering state, the controller 24 drives the transmission-ratio changing motor 18 so that the rotation speed of the carrier 22 differs from that of the first steering shaft 5. Thereby, the transmission ratio R (R=θ2/θ1) is changed.

At that time, a relationship between the steering angle θ1 and the steering torque T_{H} changes resulting from the operation of the transmission-ratio variable mechanism 8. This necessitates the compensation for the steering counter force (equivalent to the steering torque T_{H}) of the steering member 2. At this time, the controller 24 drives the counter force compensating motor 23 and imparts the first steering shaft 5 with the compensating torque so that the steering counter force is compensated. The counter force compensating motor 23 generates the compensating torque without changing the transmission ratio in the transmission-ratio variable mechanism 8.

This is preferable when the motor vehicle is in an over-steering state (or an under-steering state) as a result of traveling along a snow-covered road with a small road surface resistance, at the time of active steering such as when automatically changing the steered angle to a direction opposite to the steering direction of the steering member (automatically providing a counter), for example, because the steering counter force applied to a driver can be complemented by the counter force compensating motor 23.

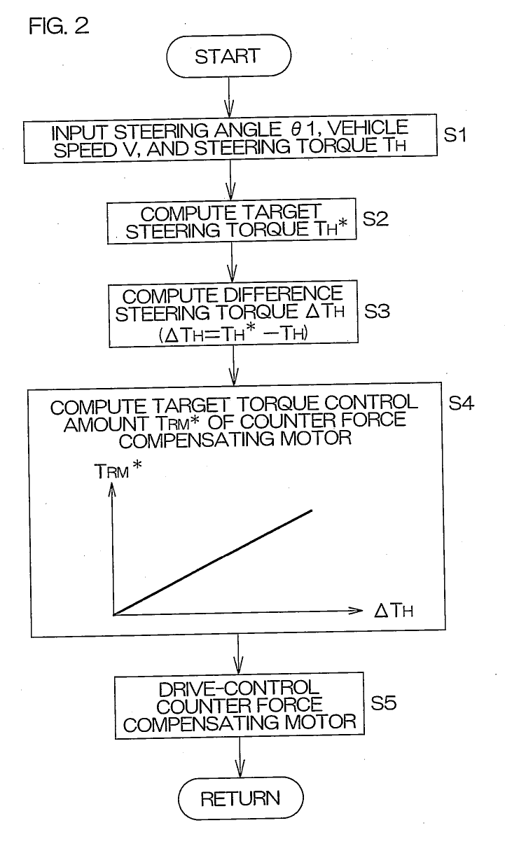

Subsequently, control when the counter force compensating motor 23 is caused to contribute to the steering assist will be described based on a flow chart in FIG. 2.

First, each detection value is read. That is, the steering angle θ1 detected by the steering angle sensor 26, the vehicle speed V detected by the speed sensor 29, and the steering torque T_{H} detected by the torque sensor 27 are read (step S1). Subsequently, based on the read steering angle θ1 and vehicle speed V, by using a previously stored map, a target steering torque T_{H}* is evaluated (step S2).

Thereafter, a difference torque ΔT_{H} (ΔT_{H}=T_{H}*−T_{H}) between the target steering torque T_{H}* and the read steering torque T_{H} is evaluated (step S3).

This is followed by computation of a target torque control amount T_{RM}* of the counter force compensating motor 23 so that the difference torque ΔT_{H}* is brought close to zero (step S4). Specifically, a map in which a relationship between the difference torque ΔT_{H} and the target torque control amount T_{RM}* is defined is previously stored, and by referring to that map, the target torque control amount T_{RM}* is evaluated. For example, in some cases, the relationship is defined in the map so that the target torque control amount T_{RM}* is proportionally increased according to an increase in the difference torque ΔT_{H}.

Based on the target torque control amount T_{RM}* thus evaluated, the counter force compensating motor 23 is drive-controlled (step S5). Specifically, a target driving electric current according to the target torque control amount T_{RM}* is set, and the driving circuit 25b performs PWM control, for example, so that the driving electric current of the counter force compensating motor 23 reaches the target driving electric current.

A torque T_{W} added to the steered wheels 4L and 4R, including the output torque T_{RM} of the counter force compensating motor 23, is expressed by the following equation (1). That is,

T_{W}=(T_{H}+T_{RM})×R+T_{PS} (1), where

T_{H}: steering torque by the driver
T_{RM}: output torque of the counter force compensating motor 23
R: transmission ratio of the transmission-ratio variable mechanism 8
T_{PS}: output torque of the hydraulic pressure steering assist mechanism 80

Therefore, a large steering assist force required for a motor vehicle such as a full-sized vehicle and a luxury vehicle mounted with the active steering function can be obtained, and thus, the present invention can be suitably applied to these vehicles. Also, by the counter force compensating motor 23, the steering assist torque is obtained. Thus, the following advantages are provided:

That is, as compared to the conventional apparatus where the flow rate of the hydraulic pressure pump is increased, a rise of the torque is more immediate, and therefore, a problem of the insufficient steering assist force can be reliably solved. Further, the prevent invention can be applied to a wider torque band. Also, irrespective of the presence of the flow-rate control valve, the present invention can be applied to various types of hydraulic pressure steering apparatuses, and thus, a high degree of versatility is provided. Moreover, a problem of the insufficient steering assist force encountered at the time of stationary steering (which is difficult to solve in the conventional apparatus where the flow rate of the hydraulic pressure pump is increased) can be solved by the present invention.

In addition, the steering assist control is requested when the steering assist force is insufficient, and at that time, the sufficient steering counter force has been given to the driver via the steering member 2, and thus, the counter force compensating control needs not to be carried out. On the other hand, the counter force compensating control is that which is requested at the time of active steering such as if the motor vehicle is in an over-steering state, for example, as a result of traveling along a snow-covered road with a small road surface resistance, the steered angle is automatically changed to a direction opposite to the steering direction of the steering member 2 (counter is automatically provided). The load at the time of such an active steering is small, and thus, the steering assist control will not be required. That is, there is no possibility that the steering assist control and the counter force compensating control are simultaneously carried out, and therefore, there is no adverse effect resulting from the interference between the both controls.

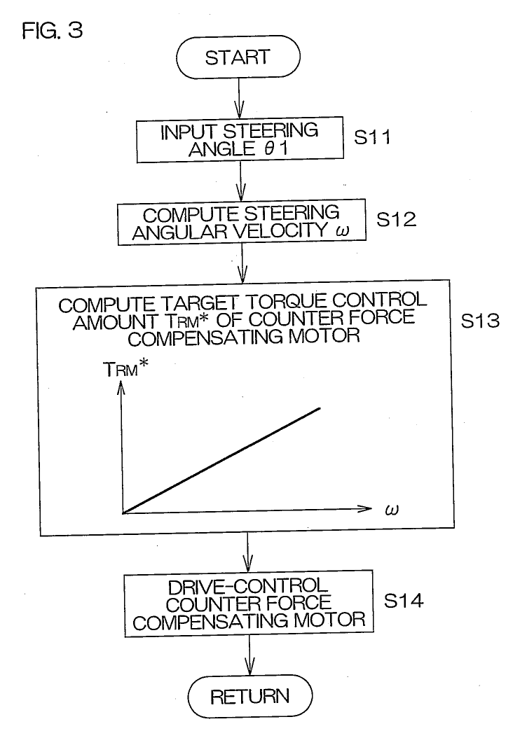

Subsequently, FIG. 3 is a flow chart when the counter force compensating motor 23 is caused to contribute to the steering assist in another embodiment of the present invention.

The steering angle θ1 detected by the steering angle sensor 26 is read (step S11), and a steering angular velocity ω that is a time differential of the read steering angle θ1 is computed (step S12).

This is followed by evaluation of the target torque control amount T_{RM}* of the counter force compensating motor 23 by using the previously stored map, based on the computed steering angular velocity ω (step S13).

Specifically, a map in which a relationship between the steering angular velocity ω and the target torque control amount T_{RM}* is defined is previously stored, and by referring to that map, the target torque control amount T_{RM}* is evaluated. For example, in some cases, the relationship is defined in the map so that the target torque control amount T_{RM}* is proportionally increased according to an increase in the steering angular velocity ω.

Based on the target torque control amount T_{RM}* thus evaluated, the counter force compensating motor 23 is drive-controlled (step S14). Specifically, a target driving electric current according to the target torque control amount T_{RM}* is set, and the driving circuit 25b performs PWM control, for example, so that the driving electric current of the counter force compensating motor 23 reaches the target driving electric current.

According to the present embodiment, the same effect and operation can be provided as those in the embodiment in FIG. 2. That is, a large steering assist force required for motor vehicles such as a full-sized vehicle and a luxury vehicle mounted thereon with the active steering function can be obtained. Further, the steering assist torque is obtained by the counter force compensating motor 23, and thus, as compared to the conventional apparatus in which the flow rate of the hydraulic pressure pump is increased, the rise of the torque is more immediate and a problem of the insufficient steering assist force can be reliably solved. Further, the present invention can be applied to a wider torque band. Also, irrespective of the presence of the flow-rate control valve, the present invention can be applied to various types of hydraulic power steering apparatuses, and thus, a high degree of versatility is provided. Moreover, a problem of the insufficient steering assist force encountered at the time of stationary steering (which is difficult to solve in the conventional apparatus where the flow rate of the hydraulic pressure pump is increased) can be solved by the present invention.

In addition, when the controller 24 is configured to control the transmission-ratio changing motor 18 based on the detected steering angle θ1 and steering angular velocity ω, the target torque control amount T_{RM}* of the counter force compensating motor 23 may be controlled stepwise so that when the steering angular velocity ω is equal to or more than a threshold value, the target torque control amount T_{RM}* of the counter force compensating motor 23 becomes equal to or more than a predetermined amount and when the steering angular velocity ω is less than the threshold value, the target torque control amount T_{RM}* falls below the predetermined amount.

In this case, the following advantages are provided: That is, in the control of the transmission-ratio variable mechanism 8, there is a case where a threshold value is provided to the steering angular velocity ω to avoid erroneous operations resulting from an error, noise, etc. Thus, for example, when the steering member 2 is operated by the steering angular velocity ω equal to or more than the threshold value, there occurs a situation where the transmission-ratio variable mechanism 8 is controlled only by the steering angular velocity ω. In this situation, in accordance with an increase in the steering angle θ1, the supply power to the transmission-ratio changing motor 18 becomes larger. Then, only when the resultant force between the output of the transmission-ratio changing motor 18 and the force generated by the hydraulic steering assist mechanism 80 exceeds the force required for moving the steered wheels 4L and 4R, the steered wheels 4L and 4R are steered.

On the other hand, as described above, when the steering angular velocity ω becomes equal to or more than the threshold value in accordance with an increase in the detected steering angle θ1, the counter force compensating motor 23 can generate a torque of which the power is equal to or more than a predetermined value with good responsiveness and can increase the steering assist force sensitively. As a result, the timing at which the steered wheels 4L and 4R start moving can be expedited.

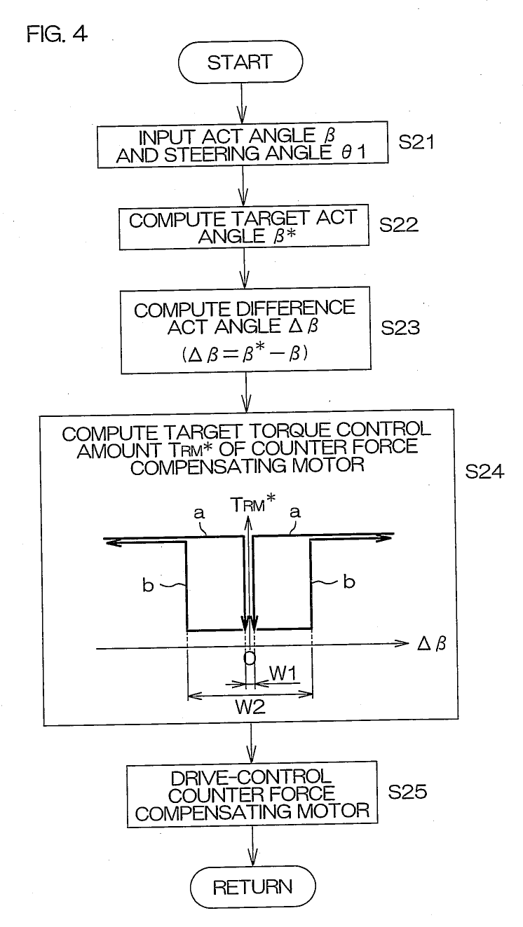

Subsequently, FIG. 4 is a flow chart when the counter force compensating motor 23 is caused to contribute to the steering assist in still another embodiment of the present invention.

In the present embodiment, an ACT angle β (detected by the rotation angle sensor 78) of the transmission-ratio changing motor 18 and the steering angle θ1 detected by the steering angle sensor 26 are read (step S21). Based on the read steering angle θ1, a target ACT angle β* (a control target value of the rotation angle of the transmission-ratio changing motor 18) is computed (step S22). Specifically, the read steering angle θ1 and a rotation transmission ratio of the transmission-ratio variable mechanism 8 are multiplied so as to compute the target ACT angle β*. In addition, the rotation transmission ratio is computed from information such as a vehicle speed value and a steering angle.

Subsequently, at step S23, a difference ACT angle Δβ (a difference between the detected ACT angle β and the target ACT angle β*) is computed (Δβ=β*−β).

Next, at step S24, based on the difference ACT angle Δβ, a previously stored map is used to evaluate a target torque control amount T_{RM}* of the counter force compensating motor 23. Based on the target torque control amount T_{RM}*, the counter force compensating motor 23 is drive-controlled. In this way, a standby mode (a state where the steering assist is insufficient) and a steering assist state (a state where the steering assist is carried out) is switched. Specifically, a target driving electric current according to the target torque control amount T_{RM}* is set, and the driving circuit 25b performs PWM control, for example, so that the driving electric current of the counter force compensating motor 23 reaches the target driving electric current.

At step S24, the transition from the steering assist state to the standby mode is carried out when the absolute value of the difference ACT angle Δβ that is, at first, out of a range of W1 gradually diminishes, and finally, enters the range of W1, as indicated by a solid line a. Further, the transition from the standby mode to the steering assist state is carried out when the absolute value of the difference ACT angle Δβ that is, at first, in a range of W2 gradually becomes larger, and finally, stays out of the range of W2, as indicated by a solid line b. In addition, in this example, in order to realize control hysteresis, the range of W2 is defined so as to encompass the range of W1.

Thus, when the difference ACT angle Δβ is equal to or more than the threshold value, control is performed so that the torque control amount T_{RM} of the counter force compensating motor 23 becomes equal to or more than a predetermined amount. Thus, the following advantages are provided: That is, even when the steering member 2 is slowly operated in a range in which the steering angular velocity ω falls below the threshold value, the steered wheels 4L and 4R can be promptly steered. The reason for this is that in this case, in accordance with an increase in the steering angle θ1, the difference ACT angle Δβ becomes larger, and thus, when the difference ACT angle Δβ becomes equal to or larger than the threshold value, the steering assist torque of which the power is equal to or more than the predetermined amount is obtained by the counter force compensating motor 23.

Therefore, for the operation of the steering member 2, the timing at which the steered wheels 4L and 4R start moving is fast, and thus, the steering feeling is improved.

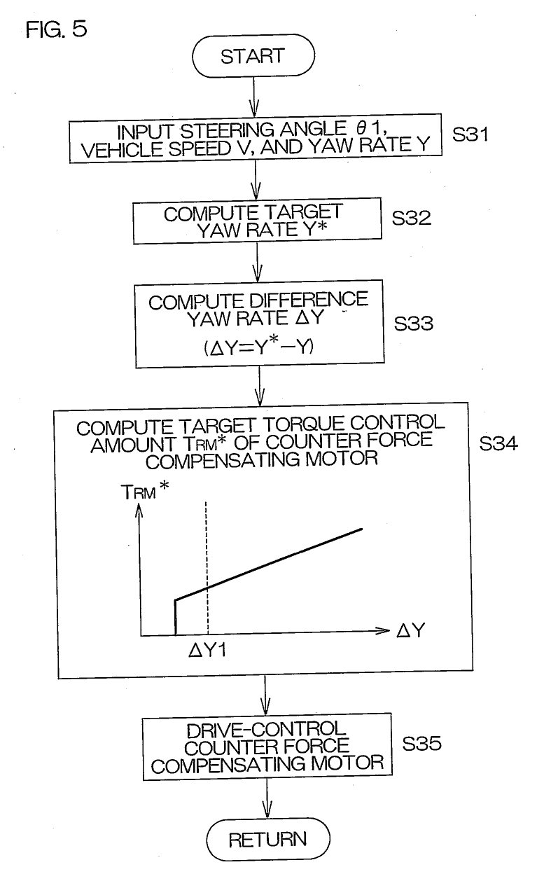

Subsequently, FIG. 5 is a flow chart when the counter force compensating motor 23 is caused to contribute to the steering assist in yet still another embodiment of the present invention.

In this embodiment, first, the steering angle θ1 detected by the steering angle sensor 26, the vehicle speed V detected by the speed sensor 29, and the yaw rate Y detected by the yaw rate sensor 30 are read (step S31).

Based on the read steering angle θ1 and vehicle speed V, the target yaw rate Y* is computed (step S32).

Subsequently, at step S33, a difference yaw rate ΔY (a difference between the detected yaw rate Y and the target yaw rate Y*) is computed (ΔY=Y*−Y).

Thereafter, at step S34, based on the difference yaw rate ΔY, a previously stored map is used to evaluate a target torque control amount T_{RM}* of the counter force compensating motor 23.

Specifically, a map in which a relationship between the difference yaw rate ΔY and the target torque control amount T_{RM}* is defined is previously stored, and by referring to this map, the target torque control amount T_{RM}* is evaluated. Based on the target torque control amount T_{RM}* thus evaluated, the counter force compensating motor 23 is drive-controlled (step S35). Specifically, a target driving electric current according to the target torque control amount T_{RM}* is set, and the driving circuit 25b performs PWM control, for example, so that the driving electric current of the counter force compensating motor 23 reaches the target driving electric current.

At step S34, in the map, a threshold value ΔY1 is set to a difference yaw rate ΔY. The threshold value ΔY1 is equivalent to a threshold value with which the transmission-ratio variable mechanism 8 starts the yaw rate control for decreasing the yaw rate. Further, it is defined in the map so that a predetermined amount of the target torque control amount T_{RM}* is generated from a difference yaw rate region smaller than the threshold value ΔY1, and the target torque control amount T_{RM}* is proportionally increased according to an increase in the difference yaw rate ΔY.

Therefore, prior to the start of the yaw rate control, the transmission-ratio variable mechanism 8 can generate the steering assist torque of which the power is equal to or more than a predetermined amount in the counter force compensating motor 23. Thus, at the time of the yaw rate control, the steering assist force will not become insufficient, and thus, the steering feeling excels.

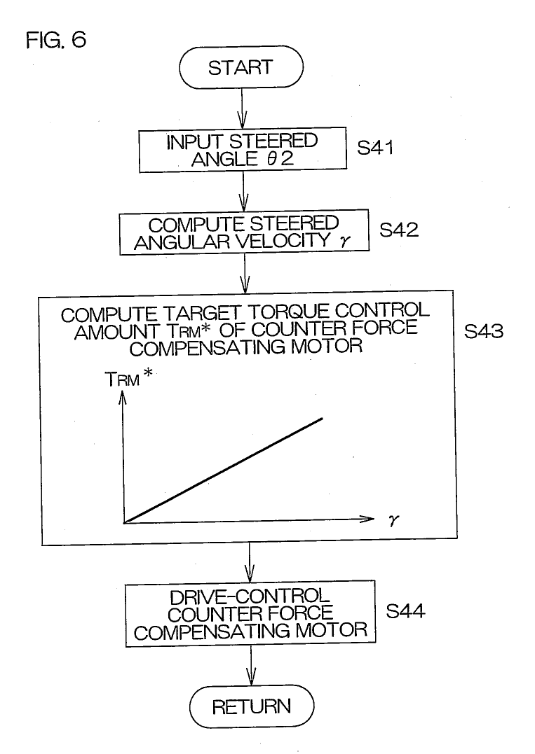

Subsequently, FIG. 6 is a flow chart when the counter force compensating motor 23 is caused to contribute to the steering assist in another embodiment of the present invention.

A steered angle θ2 detected by the steered angle sensor 28 is read (step S41). A steered angular velocity γ (equivalent to a pinion shaft angular velocity) that is a time differential of the read steered angle θ2 is computed (step S42).

Next, based on the computed steered angular velocity γ, the previously stored map is used to evaluate the target torque control amount T_{RM}* of the counter force compensating motor 23 (step S43).

Specifically, a map in which a relationship between the steered angular velocity γ and the target torque control amount T_{RM}* is defined is previously stored, and by referring to this map, the target torque control amount T_{RM}* is evaluated. For example, in some cases, the relationship is defined in the map so that the target torque control amount T_{RM}* is proportionally increased according to an increase in the steered angular velocity γ.

Based on the target torque control amount T_{RM}* thus evaluated, the counter force compensating motor 23 is drive-controlled (step S44). Specifically, a target driving electric current according to the target torque control amount T_{RM}* is set, and the driving circuit 25b performs PWM control, for example, so that the driving electric current of the counter force compensating motor 23 reaches the target driving electric current.

In the present embodiment, the same effect and operation as those in the embodiment in FIG. 3 can be provided, and a large steering assist force required for a motor vehicle such as a full-sized vehicle and a luxury vehicle mounted thereon with the active steering function can be obtained. Further, the rise of the torque is more immediate and a problem of the insufficient steering assist force can be reliably solved, and thus, the steering feeling can be improved. Also, the present invention can be applied not only to a hydraulic power steering type but also to any other type, and thus, a high degree of versatility can be provided.

The steered angular velocity γ may also be evaluated by multiplying the transmission ratio R evaluated from the ACT angle β of the transmission-ratio changing motor 18 detected by the rotation angle sensor 78 by the steering angular velocity ω that is a time differential of the steering angle θ1 detected by the steering angle sensor 26.

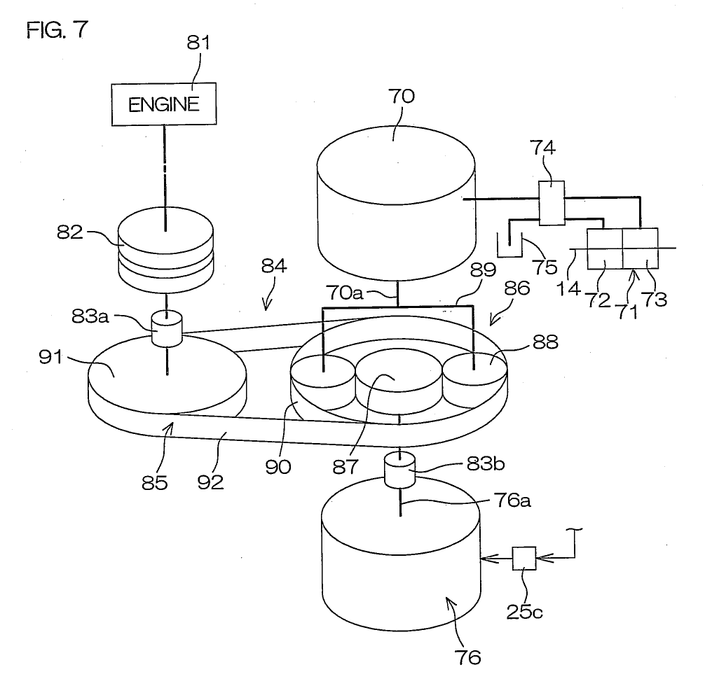

The present invention is not limited to the above-described embodiments. For example, in the embodiment in FIG. 1, the hydraulic pressure pump 70 of the hydraulic steering assist mechanism 80 is driven only by the electric motor 76. In addition thereto, hybrid drive may be adopted in which as a power source of the hydraulic pressure pump 70, the engine 81 and electric motor 76 are used, as shown in FIG. 7.

Specifically, the power of the engine 81 drives the hydraulic pressure pump 70 via a power transmission clutch 82 that can transmit the power in an on-and-off manner, one clutch 83a, and a transmission mechanism 84. The one clutch 83a permits only the power transmission from the engine 81 to the transmission mechanism 84 side.

The transmission mechanism 84 includes a belt transmission mechanism 85 and a planetary transmission mechanism 86. The planetary transmission mechanism 86 includes, for example, a sun gear 87 (as a first element) coupled, for example, integrally rotatably via the one clutch 83b with a rotation shaft 76a of the electric motor 76 so that power can be transmitted; a carrier 89 (as a second element) that supports a planetary gear 88 meshed with the sun gear 87 in a manner to permit revolution around the sun gear 87; and a ring gear 90 having internal teeth meshed with the planetary gear 88.

The carrier 89 (as a second element) is coupled, for example, integrally rotatably to the pump shaft 70a of the hydraulic pressure pump 70 so that the power can be transmitted. The ring gear 90 configures a third element for differentially rotatably coupling the sun gear 87 as a first element and the carrier 89 as a second element.

The ring gear 90 serves also as a driven pulley of the belt transmission mechanism 85. That is, the belt transmission mechanism 85 is provided with: a drive pulley 91 integrally rotatably coupled to a driven side of the one clutch 83a; and a driven pulley configured by the ring gear 90 coupled via an endless belt 92 to the drive pulley 91. That is, the ring gear 90 as a third element is coupled via the clutch 83a to the engine 81 of the motor vehicle so that the power can be transmitted.

With such a configuration, when traveling at high-speed with a light load or when responsiveness is required at the time of starting, etc., the power transmission clutch 82 is cut to block the power transmission from the engine 81 while the rotation of the drive pulley 91 or the ring gear 90 is restrained by a restraining member (for example, a braking member).

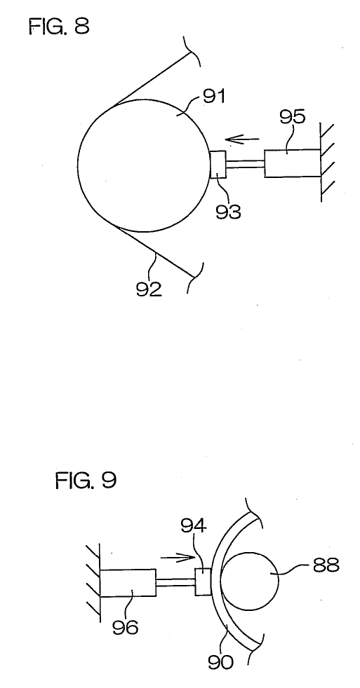

As the restraining member, a friction member 93 that can press the drive pulley 91 by compression as shown in FIG. 8, for example, and a friction member 94 that can press the ring gear 90 by compression as shown in FIG. 9, for example, can be used. Each of the friction members 93 and 94 is driven by the corresponding drive member 95 or 96. As the drive members 95 and 96, a magnetic plunger or a hydraulic pressure cylinder may be used.

When the rotation of the drive pulley 91 or the ring gear 90 is restrained, the hydraulic pressure pump 70 can be driven only by the electric motor 76. As shown in FIG. 9, when the friction member 94 is used as the restraining member, the rotation of the ring gear 90 is to be directly restrained. As shown in FIG. 8, when the rotation of the drive pulley 91 is restrained, the rotation of the ring gear 90 is to be indirectly restrained via the belt 92 by the friction member 93 as the restraining member.

The planetary transmission mechanism 86 in which the ring gear 90 is stopped by the restraint functions as a reducer, and thus, the rotation speed of the hydraulic pressure pump 70 can be decreased for the rotation speed of the electric motor 76, thereby contributing to inhibiting noise.

On the other hand, at the time of a high load such as at the time of stationary steering, the power transmission clutch 82 is connected while the restraint of the drive pulley 91 by the restraining member is canceled and the rotation of the electric motor 76 is stopped. Thereby, the hydraulic pressure pump 70 is driven only by the engine 81.

In this way, the drive is switched to the engine drive at the time of the high load, and thus, the electric motor 76 that is small with a low load may be used. By the control of the electric motor 76, the rotation speed of the hydraulic pressure pump 70 can be easily adjusted, and by extension, the adjustment of the steering assist force is easy.

Thus, the present invention is described in detail by specific modes. Those skilled in the art who understand the above-described contents may easily conceive the modifications, alternations, and equivalents. It should be therefore appreciated that the present invention covers the scope of claims and the scope of equivalents.

This application corresponds to Japanese Patent Application No. 2006-272095 filed with the Japanese Patent Office on Oct. 3, 2006, the full disclosure of which is incorporated herein by reference.

### FIG. 1

24 Controller
29 Vehicle speed sensor
30 Yaw rate sensor

### FIG. 2

### Start

S1 Input steering angle θ1, vehicle speed V, and steering torque T_{H}
S2 Compute target steering torque T_{H}*
S3 Compute difference steering torque ΔT_{H} (ΔT_{H}=T_{H}*−T_{H})
S4 Compute target torque control amount T_{RM}* of counter force compensating motor
S5 Drive-control counter force compensating motor

### Return

### FIG. 3

### Start

S11 Input steering angle θ1
S12 Compute steering angular velocity ω
S13 Compute target torque control amount T_{RM}* of counter force compensating motor
S14 Drive-control counter force compensating motor

### Return

### FIG. 4

### Start

S21 Input ACT angle β and steering angle θ1
S22 Compute target ACT angle β*
S23 Compute difference ACT angle Δβ (Δβ=β*−β)
S24 Compute target torque control amount T_{RM}* of counter force compensating motor
S25 Drive-control counter force compensating motor

### Return

### FIG. 5

### Start

S31 Input steering angle θ1, vehicle speed V, and yaw rate Y
S32 Compute target yaw rate Y*
S33 Compute difference yaw rate ΔY (ΔY=Y*−Y)
S34 Compute target torque control amount T_{RM}* of counter force compensating motor
S35 Drive-control counter force compensating motor

### Return

### FIG. 6

### Start

S41 Input steered angle θ2
S42 Compute steered angular velocity γ
S43 Compute target torque control amount T_{RM}* of counter force compensating motor
S44 Drive-control counter force compensating motor

### Return

### FIG. 7

81 Engine

1. A motor vehicle steering apparatus, comprising:
a transmission-ratio variable mechanism for changing a transmission ratio of a rotation between a first steering shaft coupled to a steering member and a second steering shaft coupled to a steering mechanism;
a transmission-ratio changing motor for changing the transmission ratio of the transmission-ratio variable mechanism;
a counter force compensating motor for compensating a steering counter force of the steering member caused by an operation of the transmission-ratio variable mechanism;
a hydraulic steering assist mechanism for generating a steering assist force by a hydraulic pressure; and
a controller for controlling the transmission-ratio changing motor and the counter force compensating motor, wherein
the controller includes a function for generating a steering assist torque in the counter force compensating motor.

2. The motor vehicle steering apparatus according to claim 1, comprising:
vehicle-speed detecting means;
steering-angle detecting means for detecting a steering angle of the steering member; and
steering-torque detecting means for detecting a steering torque of the steering member, wherein
the controller computes a target steering torque based on a vehicle speed detected by the vehicle-speed detecting means and the steering angle detected by the steering-angle detecting means, and controls the steering assist torque of the counter force compensating motor so that a difference between the computed target steering torque and the steering torque detected by the steering-torque detecting means is canceled.

3. The motor vehicle steering apparatus according to claim 1, comprising steering-angle detecting means for detecting a steering angle of the steering member, wherein
the controller controls the steering assist torque of the counter force compensating motor based on a steering angular velocity that is a time differential of the steering angle detected by the steering-angle detecting means.

4. The motor vehicle steering apparatus according to claim 1, comprising:
steering-angle detecting means for detecting a steering angle of the steering member; and
rotation-angle detecting means for detecting a rotation angle of the transmission-ratio changing motor, wherein
the controller computes a target rotation angle that is a control target value of a rotation angle of a motor in the transmission-ratio changing motor, based on the steering angle detected by the steering-angle detecting means, and controls the steering assist torque of the counter force compensating motor, based on a difference between the computed target rotation angle and the rotation angle detected by the rotation-angle detecting means.

5. The motor vehicle steering apparatus according to claim 1, comprising:
vehicle-speed detecting means;
steering-angle detecting means for detecting a steering angle of the steering member; and
yaw rate detecting means for detecting a yaw rate generated in the motor vehicle, wherein
the controller computes a target yaw rate based on the vehicle speed detected by the vehicle-speed detecting means and the steering angle detected by the steering-angle detecting means, and controls the steering assist torque of the counter force compensating motor based on a difference between the computed target yaw rate and the yaw rate detected by the yaw rate detecting means.

6. The motor vehicle steering apparatus according to claim 1, comprising steered-angle detecting means for detecting a steered angle of the steered member, wherein
the controller controls the steering assist torque of the counter force compensating motor based on a steered angular velocity that is a time differential of the steered angle detected by the steered-angle detecting means.

7. The motor vehicle steering apparatus according to claim 6, wherein
the hydraulic steering assist mechanism comprises:
a power cylinder for generating the steering assist force;
a hydraulic pressure pump for supplying the power cylinder with pressure oil; and
an electric motor capable of driving the hydraulic pressure pump,
the hydraulic steering assist mechanism further comprises:
a planetary transmission mechanism for coupling a pump shaft of the hydraulic pressure pump and a rotation shaft of the electric motor; and
a restraining member,
the planetary transmission mechanism includes:
a first element coupled via a clutch to the rotation shaft of the electric motor so that power can be transmitted;
a second element coupled to the pump shaft of the hydraulic pressure pump so that power can be transmitted; and
a third element which is differentially rotatably coupled to the first and second elements and of which rotation can be restrained by a restraining member,
the third element is coupled via a clutch to an engine of the motor vehicle so that power can be transmitted, and
the restraining member is able to restrain the rotation of the third element directly or indirectly.

8. The motor vehicle steering apparatus according to claim 5, wherein
the hydraulic steering assist mechanism comprises:
a power cylinder for generating the steering assist force;
a hydraulic pressure pump for supplying the power cylinder with pressure oil; and
an electric motor capable of driving the hydraulic pressure pump,
the hydraulic steering assist mechanism further comprises:
a planetary transmission mechanism for coupling a pump shaft of the hydraulic pressure pump and a rotation shaft of the electric motor; and
a restraining member,
the planetary transmission mechanism includes:
a first element coupled via a clutch to the rotation shaft of the electric motor so that power can be transmitted;
a second element coupled to the pump shaft of the hydraulic pressure pump so that power can be transmitted; and
a third element which is differentially rotatably coupled to the first and second elements and of which rotation can be restrained by a restraining member,
the third element is coupled via a clutch to an engine of the motor vehicle so that power can be transmitted, and
the restraining member is able to restrain the rotation of the third element directly or indirectly.

9. The motor vehicle steering apparatus according to claim 4, wherein
the hydraulic steering assist mechanism comprises:
a power cylinder for generating the steering assist force;
a hydraulic pressure pump for supplying the power cylinder with pressure oil; and
an electric motor capable of driving the hydraulic pressure pump,
the hydraulic steering assist mechanism further comprises:
a planetary transmission mechanism for coupling a pump shaft of the hydraulic pressure pump and a rotation shaft of the electric motor; and
a restraining member,
the planetary transmission mechanism includes:
a first element coupled via a clutch to the rotation shaft of the electric motor so that power can be transmitted;
a second element coupled to the pump shaft of the hydraulic pressure pump so that power can be transmitted; and
a third element which is differentially rotatably coupled to the first and second elements and of which rotation can be restrained by a restraining member,
the third element is coupled via a clutch to an engine of the motor vehicle so that power can be transmitted, and
the restraining member is able to restrain the rotation of the third element directly or indirectly.

10. The motor vehicle steering apparatus according to claim 3, wherein
the hydraulic steering assist mechanism comprises:
a power cylinder for generating the steering assist force;
a hydraulic pressure pump for supplying the power cylinder with pressure oil; and
an electric motor capable of driving the hydraulic pressure pump,
the hydraulic steering assist mechanism further comprises:
a planetary transmission mechanism for coupling a pump shaft of the hydraulic pressure pump and a rotation shaft of the electric motor; and
a restraining member,
the planetary transmission mechanism includes:
a first element coupled via a clutch to the rotation shaft of the electric motor so that power can be transmitted;
a second element coupled to the pump shaft of the hydraulic pressure pump so that power can be transmitted; and
a third element which is differentially rotatably coupled to the first and second elements and of which rotation can be restrained by a restraining member,
the third element is coupled via a clutch to an engine of the motor vehicle so that power can be transmitted, and
the restraining member is able to restrain the rotation of the third element directly or indirectly.

11. The motor vehicle steering apparatus according to claim 2, wherein
the hydraulic steering assist mechanism comprises:
a power cylinder for generating the steering assist force;
a hydraulic pressure pump for supplying the power cylinder with pressure oil; and
an electric motor capable of driving the hydraulic pressure pump,
the hydraulic steering assist mechanism further comprises:
a planetary transmission mechanism for coupling a pump shaft of the hydraulic pressure pump and a rotation shaft of the electric motor; and
a restraining member,
the planetary transmission mechanism includes:
a first element coupled via a clutch to the rotation shaft of the electric motor so that power can be transmitted;
a second element coupled to the pump shaft of the hydraulic pressure pump so that power can be transmitted; and
a third element which is differentially rotatably coupled to the first and second elements and of which rotation can be restrained by a restraining member,
the third element is coupled via a clutch to an engine of the motor vehicle so that power can be transmitted, and
the restraining member is able to restrain the rotation of the third element directly or indirectly.

12. The motor vehicle steering apparatus according to claim 1, wherein
the hydraulic steering assist mechanism comprises:
a power cylinder for generating the steering assist force;
a hydraulic pressure pump for supplying the power cylinder with pressure oil; and
an electric motor capable of driving the hydraulic pressure pump,
the hydraulic steering assist mechanism further comprises:
a planetary transmission mechanism for coupling a pump shaft of the hydraulic pressure pump and a rotation shaft of the electric motor; and
a restraining member,
the planetary transmission mechanism includes:
a first element coupled via a clutch to the rotation shaft of the electric motor so that power can be transmitted;
a second element coupled to the pump shaft of the hydraulic pressure pump so that power can be transmitted; and
a third element which is differentially rotatably coupled to the first and second elements and of which rotation can be restrained by a restraining member,
the third element is coupled via a clutch to an engine of the motor vehicle so that power can be transmitted, and
the restraining member is able to restrain the rotation of the third element directly or indirectly.
